(19) United States
(12) Patent Application Publication
(10) Pub. No.: US 2020/0405445 A1
(43) Pub. Date: Dec. 31, 2020

(54) ORTHODONTIC APPLIANCES, DIGITAL TOOLS, AND METHODS FOR DENTAL TREATMENT PLANNING

(71) Applicant: Ormco Corporation, Orange, CA (US)

(72) Inventors: Evan Yifeng Tsai, Rancho Cucamonga, CA (US); Kees Wind, Newport Beach, CA (US); Warren Day, Newport Beach, CA (US); Artem Borovinskih, San Jose, CA (US)

(21) Appl. No.: 16/978,892

(22) PCT Filed: Mar. 13, 2019
(86) PCT No.: PCT/US2019/021993

§ 371 Date: Sep. 8, 2020

Related U.S. Application Data
(60) Provisional application No. 62/642,319, filed on Mar. 13, 2018.

(51) Int. Cl. A61C 7/00; A61C 7/14

(52) U.S. Cl. CPC A61C 7/002; A61C 7/14

(57) ABSTRACT

An orthodontic appliance for dental treatment includes an aligner or a bracket having a dimension (G, I, V) that compensates for a restorative treatment. The dimension (G, I, V) compensates for gingival alteration, hard tissue build-up, or hard tissue removal on the patient's teeth. An apparatus (10) for smile design includes a first data structure (20) that defines a digital 3-D smile template (100) of teeth arranged in accordance with predetermined criteria. A method of planning dental treatment of a patient includes superimposing a digital 3-D smile template (100) of teeth with a digital orthodontic setup (26) of a patient's teeth. A computer program product (300) for smile design includes instructions that cause a processor (302) to retrieve a first data structure (318) that defines a smile template (100) of teeth arranged in accordance with predetermined criteria, retrieve a second data structure (318) that defines an orthodontic setup (26) of a patient's teeth, and superimpose the smile template (100) on the digital orthodontic setup (26) using the first and second data structures (318).

### CROSS REFERENCE

This application claims the benefit of U.S. Provisional Patent Application Ser. No. 62/642,319 filed on Mar. 13, 2018, and is a national stage entry of international application no. PCT/US2019/021993 filed Mar. 13, 2019, each of the disclosures of which is expressly incorporated by reference herein in its entirety.

### TECHNICAL FIELD

The invention relates generally to the field of dentistry and, more particularly, to computerized development of orthodontic appliances, orthodontic treatment and restorative treatment planning.

### BACKGROUND

An objective for orthodontic treatment is repositioning of a patient's teeth to locations where the individual teeth function optimally together. These locations may generally define a pair of opposed and cooperating planar, or nearly planar, smooth arches. The teeth of the two arches, when in optimal or ideal positions, contact the teeth of the opposite arch along a surface that is usually flat or slightly upwardly concave and commonly referred to as the plane of occlusion. Treatment also addresses the aesthetics of the patient's smile.

To each of these ends, orthodontic treatment includes tooth movement relative to the respective alveolar bone to bring a patient's teeth as closely as possible or practical to their ideal positions. To move teeth, an orthodontist will apply an appliance to the teeth to exert forces on them. The applied forces gradually urge one or more teeth toward their ideal positions. Appliances include orthodontic brackets and archwires or aligners capable of imposing forces on those teeth in a direction that is generally toward their final, ideal positions.

To identify their final, ideal positions and at the outset of treatment, a model of a patient's teeth is produced. The model aids the clinician and others involved in orthodontic treatment in making treatment decisions. Software may be used to manipulate the model to identify ideal positions and plan the movement of any single one or all of the teeth from an initial position to their final post-treatment positions. This may facilitate the design of orthodontic brackets, archwires, and/or aligners specific to that patient prior to application of those appliances to the patient's condition. The model may provide quantitative and qualitative information regarding distances and spatial relationships between adjacent teeth on one jaw and teeth on the opposing jaws.

Models may include plaster dental models, which are made by casting plaster into the negative impression made by teeth in an appropriate matrix. More often, dental models are prepared from images of the patient's teeth and so exist electronically. By way of example, the dental practitioner may take impressions and scan them, capture visible light imagery of the teeth, and capture X-ray images of the teeth and the surrounding skeletal structure. The X-ray images may be generated via digital radiography in which a digital image capture device is used for recording the X-ray images, and subsequently the X-ray images are saved as digital files. The X-ray images may include panoramic X-rays and cephalometric X-rays. The panoramic X-rays may show the relative positions of the teeth in each of the upper jaw and the lower jaw. The cephalometric X-rays may show the skeletal relationships associated with the teeth in different views of the head. The celphalometric X-ray may also provide information about various angles and relationships associated with the teeth and the surrounding facial skeletal structure. Software may be used to help quantify various measurements, for example, the angles and measurements for cephalometric analysis from the digital cephalometric X-rays.

Another imaging methodology is cone beam computed tomography (CBCT), which involves the use of a rotating CBCT scanner, combined with a digital computer, to obtain images of the teeth and surrounding bone structure, soft tissue, muscle, blood vessels, etc. CBCT may be used in a dental practitioner's office to generate cross sectional images of teeth and the surrounding bone structure, soft tissue, muscle, blood vessels, etc. During a CBCT scan, the CBCT scanner rotates around the patient's head and may obtain hundreds of distinct CBCT images. The scanning software collects and analyzes the CBCT images to generate three-dimensional anatomical data. The three-dimensional anatomical data can then be manipulated and visualized with specialized software to allow for cephalometric analysis of the CBCT images.

A dental practitioner may write a prescription based on an analysis of the impression of the teeth or one or more of the images. The prescription written by the dental practitioner may be used to manufacture one or more orthodontic brackets. Alternatively, or in addition to brackets, the prescription may be used to manufacture clear removable plastic aligners.

While effective, modeling a patient's teeth is not without difficulties. As a result of the difficulties in imaging and assessing tooth movement based on a prescription, the effect of orthodontic treatment is often uncertain. Nevertheless, despite the uncertain nature of treatment, patients naturally desire to see what the result of treatment will be prior to the start of treatment. Patients want to see their smile at the conclusion of treatment. Orthodontics and orthodontic professionals therefore strive to provide an objective assessment of treatment and ultimately provide a visual result of that treatment. While digital orthodontic solutions have enabled more accurate predictions and simulations of teeth movement, doctors are still left to some guesswork and trial and error when the patient's smile is at issue. For example, current modeling fails to consider the cosmetic treatment aspects of smile design. As such, practitioners are unable to utilize all the available treatments when developing a prescription. What is needed are orthodontic appliances, computer modeling tools and systems, and treatment preparation methods that incorporate cosmetic dentistry methods.

### SUMMARY

The present invention overcomes the foregoing and other shortcomings and drawbacks of dental planning and treatment. While the invention will be described in connection with certain embodiments, it will be understood that the invention is not limited to these embodiments. On the contrary, the invention includes all alternatives, modifications and equivalents as may be included within the spirit and scope of the present invention.

According to one aspect of the present invention, an orthodontic appliance for dental treatment of a patient comprises one of an aligner and an orthodontic bracket which includes a dimension that compensates for a restorative treatment performed on the patient before, during, or after orthodontic treatment of the patient with the aligner or orthodontic bracket. In one embodiment, the dimension compensates for at least one of gingival alteration, hard tissue build-up, and hard tissue removal on one or more of the patient's teeth.

In one embodiment, the dimension compensates for hard tissue removal or hard tissue build-up on one or more of the patient's teeth.

According to one aspect of the present invention, an apparatus for smile design including a computer having a processor comprises a memory coupled to the processor, the memory storing a first data structure that defines a digital 3-D smile template of at least two teeth arranged in accordance with predetermined criteria.

In one embodiment, the apparatus further includes a second data structure that defines a digital orthodontic setup of a patient's teeth, and program code that, when executed by the processor, causes the computer to superimpose the digital 3-D smile template on the digital orthodontic setup of a patient's teeth using the first and second data structures.

In one embodiment, the apparatus further includes a user interface for selectively attaching the digital 3-D smile template to the digital orthodontic setup and program code that, when executed by the processor, causes the computer to attach at least one tooth in the digital 3-D smile template to at least one tooth in the digital orthodontic setup using the first and second data structures.

In one embodiment, the apparatus further comprises a second data structure that defines a digital orthodontic setup of a patient's teeth, and a user interface for selectively displaying at least one microesthetic value of at least one tooth in the digital orthodontic setup. The program code, when executed by the processor, causes the computer to calculate the at least one microesthetic value of the at least one tooth of the digital orthodontic setup when a user selects the at least one microesthetic value for display using the second data structure.

In one embodiment, the predetermined criteria include a tooth style and a tooth size.

In one embodiment, the predetermined criteria include tooth proportions.

In one embodiment, the digital 3-D smile template includes a set of maxillary anterior 3 to 3 teeth.

In one embodiment, the first data structure defines a grid on a surface of one or more of the teeth of the 3-D smile template.

In one embodiment, the apparatus further comprises a user interface, and program code that, when executed by the processor, causes the computer to modify one or more of the predetermined criteria based on numerical values entered via the user interface.

In one embodiment, the apparatus further comprises a user interface, and program code that, when executed by the processor, causes the computer to calculate at least one microesthetic value of at least one tooth in the 3-D smile template using the first data structure.

In one embodiment, the apparatus further comprises a user interface including a set of tools, and program code that, when executed by the processor, causes the computer to move the 3-D smile template within a 3-D digital environment in accordance with selection and movement of one of the set of tools.

According to one aspect of the present invention, a method of planning dental treatment of a patient comprises superimposing a digital 3-D smile template of one or more teeth with a digital orthodontic setup of a patient's teeth.

In one embodiment, the digital 3-D smile template is based on at least one predetermined criteria and the method further includes modifying a T2 model based on at least one of the predetermined criteria.

In one embodiment, modifying the T2 model includes modifying data in the digital orthodontic setup so that the T2 model includes data that compensates for a restorative treatment after orthodontic treatment of the patient with an orthodontic appliance.

In one embodiment, the data compensates for one at least of gingival alteration, hard tissue build-up, or hard tissue removal on at least one tooth of the patient.

In one embodiment, the data compensates for hard tissue removal or hard tissue build-up on at least one tooth of the patient.

According to one aspect of the present invention, a computer program product for smile design comprises a non-transitory computer-readable storage medium, and program code stored on the non-transitory computer-readable storage medium that, when executed by a processor, causes the processor to (i) retrieve a first data structure that defines a digital 3-D smile template of at least two teeth arranged in accordance with predetermined criteria from a memory, (ii) retrieve a second data structure that defines an orthodontic setup of a patient's teeth from the memory, and (iii) superimpose the digital 3-D smile template of the at least two teeth on the digital orthodontic setup of a patient's teeth using the first and second data structures.

In one embodiment, the digital 3-D smile template is based on at least one predetermined criteria and the program code causes the processor to modify a T2 model based on at least one of the predetermined criteria.

In one embodiment, the program code causes the processor to modify data in the digital orthodontic setup so that the T2 model includes data that compensates for a restorative treatment after orthodontic treatment of the patient with an orthodontic appliance.

In one embodiment, the data compensates for one at least of gingival alteration, hard tissue build-up, or hard tissue removal on at least one tooth of the patient.

In one embodiment, the data compensates for hard tissue removal or hard tissue build-up on at least one tooth of the patient.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a flow diagram and exemplary apparatus for orthodontic treatment according to one embodiment of the invention.

FIG. 2 is a perspective view of an exemplary 3-D smile template including a grid according to one embodiment of the invention.

FIG. 3 is an exemplary schematic view of a user interface for modifying a 3-D smile template according to one embodiment of the invention.

FIG. 4 is a perspective view of a 3-D smile template superimposed on a digital orthodontic setup for a patient.

FIG. 5 is an exemplary schematic view of a user interface for display controls related to the perspective view shown in FIG. 4 according to one embodiment of the invention.

FIG. 6A is a perspective view of an exemplary 3-D smile template with microesthetic values according to one embodiment of the invention.

FIG. 6B is a perspective view of a digital orthodontic setup with microesthetic values according to one embodiment of the invention.

FIG. 7 is a schematic enlarged view of a tooth of a 3-D smile template shown in FIG. 4 superimposed on a tooth of the digital orthodontic setup.

FIG. 8 is a schematic enlarged view of the tooth shown in FIG. 7 after the tooth of the digital orthodontic setup is moved according to a treatment plan.

FIG. 9 is an exemplary schematic view of a user interface for clinical assessment and actions with respect to the schematic enlarged view shown in FIGS. 7 and 8.

FIGS. 10A and 10B illustrate an exemplary set of tools for manipulating the 3-D smile template shown in FIG. 2.

FIG. 11 depicts different teeth proportions in relation to selections made in the user interface shown in FIG. 3 and the tools shown in FIGS. 10A and 10B.

FIG. 12 is a schematic view of a computer device or system usable in the apparatus of FIG. 1.

FIG. 13 is an exemplary orthodontic appliance according to one embodiment of the invention.

FIG. 14 is an exemplary orthodontic appliance according to one embodiment of the invention.

FIG. 15 is an exemplary orthodontic appliance according to one embodiment of the invention.

### DETAILED DESCRIPTION

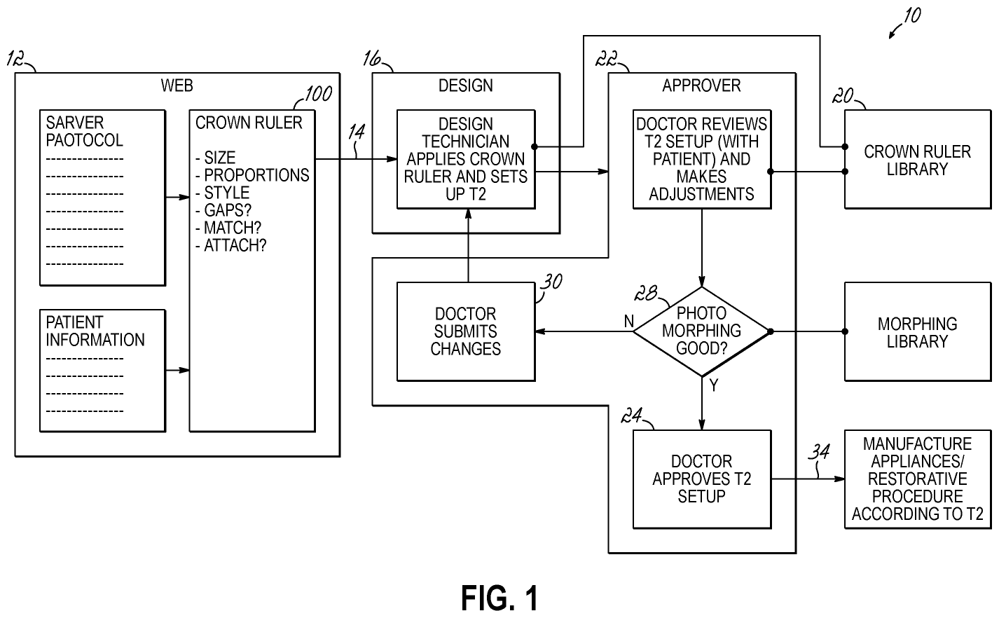

To these and other ends and with reference to FIG. 1, an exemplary diagram illustrates development of an orthodontic treatment plan according to one embodiment of the invention. Systems and methods that use computer programs to model a patient's teeth, to design orthodontic treatment and appliances, and to model a patient's smile have been proposed by applicant, examples of which are disclosed in U.S. Pat. No. 9,529,970 and International Application No. PCT/US2003/030917, filed on Sep. 26, 2003, and International Patent Application No. PCT/US2000/035558, filed Dec. 29, 2000, all of which are hereby expressly incorporated herein by reference in their entireties. These systems provide an interface through which a treating orthodontist or other dental practitioners can communicate treatment and design preferences and exchange patient data. Embodiments of the present invention provide enhancements to such systems that improve the functionality and utility of such systems and improve treatment efficiency while reducing treatment costs, as set forth herein.

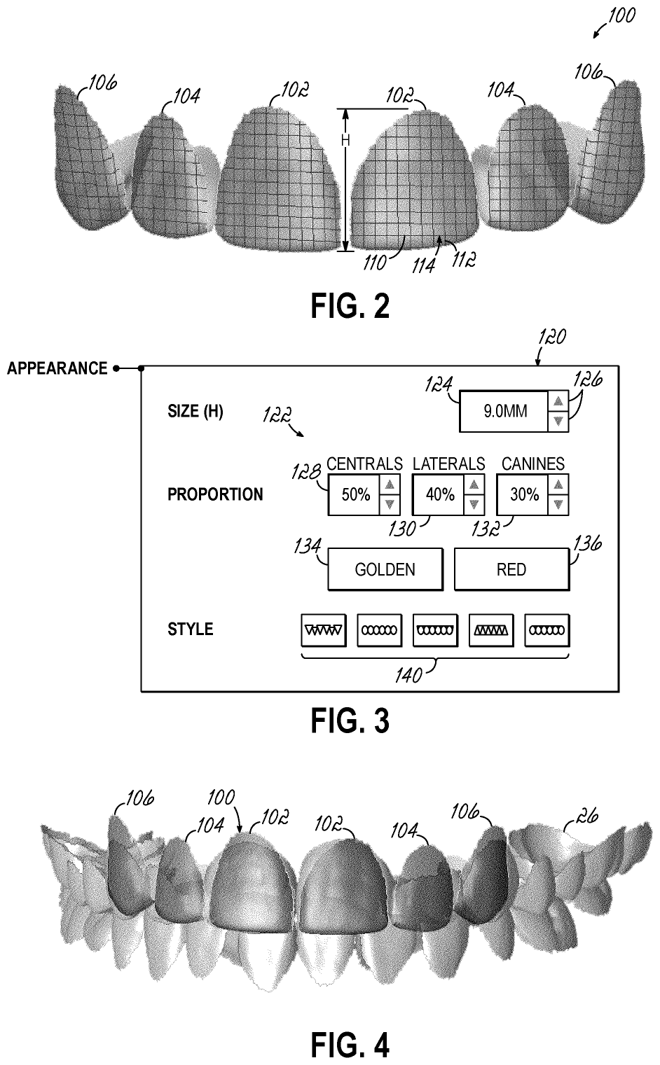

With reference to FIGS. 1 and 2, an apparatus 10 of the present invention incorporates one or more smile templates that are referred to herein as “crown rulers.” An exemplary crown ruler 100 is shown in FIG. 2 and described below. The crown ruler 100 is a virtual 3-D model of an ideal smile (i.e., a 3-D smile template) and in one embodiment, provides a capability of quantitatively measuring deviations between one or more digital orthodontic setups from an ideal smile in a virtual 3-D environment. According to one embodiment, a crown ruler is constructed by scanning individual ideal model teeth. The scanned data from the physical model is then manipulated to construct a virtual 3-D tooth that corresponds to the physical ideal model tooth. Selected individual virtual 3-D teeth are then assembled in the virtual environment into a crown ruler. This process includes arranging the individual virtual 3-D teeth along an ideal arc, such as that defined by an orthodontic archwire. By way of example only, the incisal edges of the individual teeth are aligned on the ideal arc. Alternatively, an entire model arch, such as a typodont, which includes many model teeth, may be scanned. Individual ones of the teeth are individually, digitally selected from that scan and arranged along an ideal arc. The ideal arc may be provided by the typodont. The crown rulers 100 are therefore predetermined and are not associated with a particular person. The crown ruler 100 is a visual guide that facilitates the development of T2. In FIG. 1, in one embodiment, the crown ruler 100 is made available via a website 12 together with patient information and a measurement protocol, for example according to Dr. David Sarver (i.e., “Sarver Protocol”). The patient information may be collected according to the procedures described in commonly owned U.S. Pub. No. 2014/0122027, which is incorporated by reference herein in its entirety. The patient information includes dental imagery that is captured via imaging devices at a clinic site.

The clinic site may have a plurality of imaging devices. These devices may include cameras, video cameras, intra-oral scanners, cone beam scanners, x-ray machines, magnetic resonance imagery machines, ultrasound machines, and other imaging devices. A dental practitioner uses one or more of these imaging devices to generate digital imagery of the patient's teeth, jaws, soft tissue, and other features to produce a 3-D model on a computer of the patient's teeth from the captured digital imagery. This digital orthodontic model is often referred to as the “T1 model” and is a 3-D digital representation of the patient's teeth prior to treatment. In any respect, the captured digital imagery and/or the T1 model are made available via the web 12 shown in FIG. 1.

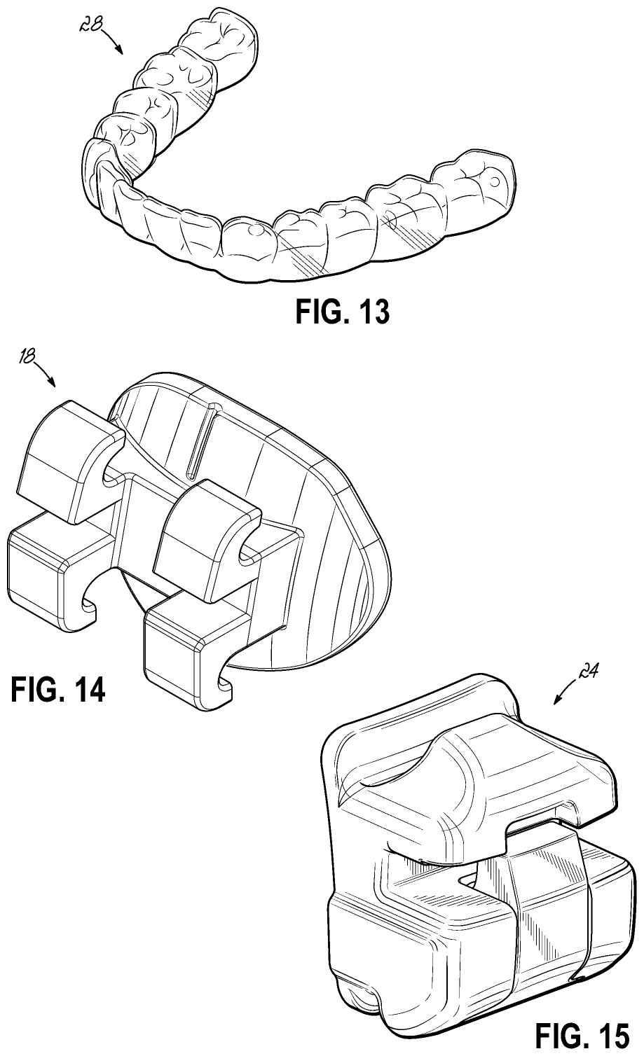

In the exemplary apparatus 10, the practitioner (e.g., a dental technician) may access each of the patient information (e.g., the digital imagery) and one or more crown rulers 100 through the web 12 according to arrow 14. At 16, the practitioner applies the crown ruler 100 to the patient information in a digital environment. By way of example only, the practitioner may apply the crown ruler 100 to set up a T2 model (also referred to as “T2” herein). The T2 model is a digital 3-D model that represents one possible after-treatment arrangement of the virtual teeth shown in the T1 model. That is, T2 is a virtual representation of the patient's teeth that corresponds exactly to one proposed outcome of dental treatment. From T2, a treatment plan is produced that may ultimately be used to instruct the orthodontic manufacturer on the design of orthodontic appliances, such as orthodontic brackets and aligners. Exemplary orthodontic brackets 18, 24 and aligners 28 are shown in FIGS. 13, 14, and 15. That treatment plan may alternatively or also include restorative dental procedures as is further described herein.

The practitioner may be remote from the clinic site as is schematically represented by box 16 and may access all of the information necessary to produce a proposed T2 from which a treatment plan may be prepared for the patient. Embodiments of the invention are not limited to accessing crown rulers 100 and patient information on a computer via the web 12. As an alternative, for example, the practitioner may access all the available information on a standalone computer at the clinic site. Without limitation, the clinic site may be a dentist's office, an orthodontist's office, a hospital, a clinic, an imaging center, or a manufacturing site. As is described below, according to embodiments of the invention, a practitioner implements a computer (see FIG. 12) with software capable of generating and utilizing one or more of the crown rulers 100 in conjunction with a digital orthodontic setup, such as T2, to plan one of orthodontic treatment, restorative treatment, or a combination of orthodontic and restorative treatment.

Selection of the orthodontic and/or restorative treatments may depend on the patient and other factors, such as, the patient's expectations as to their smile, the duration of treatment, doctor skills, and cost. Orthodontic techniques include movement of individual teeth relative to the patient's jaw, such as rotation and tipping of individual teeth, and arch expansion. Restorative techniques may include gingival alteration, such as re-contouring, and hard tissue build-up or removal on individual teeth.

At 16, T2 is set up based on patient information, for example, from a T1 model. During this process, the practitioner applies one or more of the crown rulers 100 from a crown ruler library 20 containing a plurality of different crown rulers to the digital orthodontic setup to produce T2 in a 3-D virtual computer-generated environment. The crown ruler library 20 may be accessible on the computer on which the practitioner is located or the practitioner may access the library 20 remotely. With reference to FIG. 2, the crown ruler 100 permits the practitioner to visualize treatment outcomes focusing on the patient's smile as a result of those treatments. The practitioner may then select the best possible treatment in accordance with the patient's desired smile. In conjunction with the crown ruler 100, the practitioner manipulates patient information, such as T2, and receives ongoing visual feedback on those manipulations. Advantageously, the workflow shown in FIG. 1, including the use of the crown ruler 100, reduces time during approval at box 22 to arrive at an approved T2 at 24.

With reference to FIG. 2, the crown ruler 100 is a 3-D digital surface model representing maxillary teeth in an ideal shape and alignment. The crown rulers 100 are constructed based on predetermined criteria and are thus objective 3-D models of teeth arranged in an aesthetically pleasing smile configuration. Their construction is based on various known tooth shapes and objective aesthetic rules regarding smile design. However, the crown rulers 100 are modifiable to take into account individual anatomical characteristics of the patient based on aesthetic rules. These rules are described at length in the '027 publication. Each crown ruler 100 is a template of an ideal aesthetic smile that abides by one or more aesthetic rules. In general, these rules incorporate anthropomorphic measurements and so the effect of the rules is quantitative. The practitioner selects one of many crown rulers 100 from the library 20 during the preparation of T2. During preparation, the practitioner may apply multiple crown rulers before arriving at a particular crown ruler for a particular patient. As is described below, once selected, that particular crown ruler may be modified for that particular patient.

An exemplary crown ruler 100 is shown in FIG. 2 which includes anterior 3 to 3 teeth. As shown, the ruler 100 includes the central incisors 102, the lateral incisors 104, and canines 106. It will be appreciated that crown rulers 100 may depict all of the teeth on the maxillary jaw according to embodiments of the invention. Further, the crown ruler 100 may include some or all of the teeth on the patient's mandibular jaw. However, when a patient smiles, it is generally the upper anterior 3 to 3 teeth that are visible. Focusing on adjusting these teeth by orthodontic and restorative treatment based on a selected crown ruler provides an improved aesthetic smile without the additional visual considerations associated with adjusting all of the teeth to arrive at T2. In one embodiment, the practitioner may modify the patient's digital orthodontic set up to match the crown ruler 100 during a setup of T2.

Also shown in the exemplary embodiment, each tooth in the crown ruler 100 includes a plurality of horizontal lines 110 (i.e., mesial-distal extending) and a plurality of vertical lines 112 (i.e., gingival-occlusal extending), which define a grid 114. The grid 114 follows an outer surface of each model tooth 102, 104, and 106. For example, the grid 114 follows the labial surface of the teeth 102, 104, and 106. The grid 114 is not merely superimposed on a 2-D plane of the image of the crown ruler 100 and instead represents a surface portion of each 3-D model tooth 102, 104, and 106. The grid 114 is modifiable in accordance with the modifications, described below, that are possible with each crown ruler 100.

As shown, the horizontal lines 110 are equally spaced and the vertical lines 112 are equally spaced. By way of example only and not limitation the spacing may be 1 mm between the horizontal lines 110 and may be 1 mm between the vertical lines 112. However, embodiments of the present invention are not limited to 1 mm spacing nor to the equal spacing between the horizontal lines 110 and the vertical lines 112.

Referring to FIGS. 1, 2, and 3, during the selection and/or application of the crown ruler 100 to a digital orthodontic setup of the patient's teeth, such as to T2 or to an intermediate model leading up to T2, the clinician may modify the appearance of the crown ruler 100 via one or more user interfaces to adjust objective criteria of the crown ruler 100. The objective, predetermined criteria control the appearance of the crown ruler 100 and are based on mathematical calculations or are based on predetermined data not associated with the patient.

An exemplary user interface 120 is shown in FIG. 3 by which the practitioner may adjust one or more of the predetermined criteria by way of settings 122 to account for deviations between the patient's anatomical characteristics and the selected crown ruler 100. As the clinician adjusts any single one of the settings 122, the crown ruler 100 is automatically visually updated. In this way, the practitioner may assess whether the selected crown ruler 100 is appropriate for that particular patient.

By way of example only, a size (H) setting 124 may adjust an occlusal-gingival height of the central incisor 102 of the crown ruler 100 shown in FIG. 2. The clinician may change the size (H) setting 124 by direct insertion of a numerical value or by activation of up and down arrows 126 to increment the size (H) setting by 0.1 mm, for example. As the value of the size (H) setting 124 is increased or is decreased by either a direct insertion or by selection of arrows 126, the crown ruler 100 (i.e., teeth 102, 104, and 106) is automatically scaled up or down in actual height dimension. The scaling is uniformly applied to the crown ruler 100 so that the proportions of the teeth 102, 104, 106 do not change. For example, if the practitioner increases the value, the number of horizontal lines 110 and the number of vertical lines 112 that define the grid 114 increases and if the practitioner decreases the value, the number of horizontal lines 110 and the number of vertical lines 112 that define the grid 114 decreases. In other words, the teeth become larger or smaller in the virtual 3-D space as the size (H) setting 124 is increased or decreased, respectively.

Also shown in FIG. 3, proportion settings 128, 130, 132 provide for individual adjustment of the visual widths relative to the size (H) of the central incisor 102. Adjustment of the proportion settings 128, 130, 132 for each of the central incisors 102, lateral incisors 104, and canines 106, respectively, is possible. Each of the values 128, 130, 132 represents a visual width of the corresponding tooth 102, 104, and 106 as it is perceived in a frontal view (e.g., FIG. 2). As shown, the values 128, 130, 132 are percentages and are related to the size (H) setting 126 described above.

As an alternative to the proportion settings 128, 130, and 132, the practitioner may select a proportion setting according to one of two buttons to select the teeth proportions based on a Golden Proportion 134 or a Recurring Esthetic Dental (RED) Proportion 136. The Golden Proportion is a ratio between larger and smaller widths. The ratio is approximately 1.618:1. Generally, according to this ratio a smaller tooth is about 62% of a width dimension of a larger tooth. The RED Proportion is a proportion of widths of teeth as viewed from the front in which the proportions remain constant between adjacent teeth from the midline in the mesial or distal directions. That is, the width ratio between a central incisor and a lateral incisor should be the same ratio as between the lateral incisor and a canine. Those ratios may not be 62%. When selected, the Golden proportion 134 or the RED Proportion 136 overrides the values 128, 130, 132 of the proportion setting.

In one embodiment, a style setting 140 allows the clinician to select the crown ruler 100 according to common shapes of teeth. By way of example only, the teeth shapes may be from the LVI Smile Library.

Once any single one of the settings 122 is modified, the crown ruler 100 is visually updated according to the new value for that setting 122. Advantageously, the settings 122 may be adjusted while the crown ruler 100 is superimposed with the patient's digital orthodontic setup, as is described below. The practitioner can therefore make on-the-fly modifications to the crown ruler 100 and visually analyze the deviations of the digital orthodontic setup 26 from the modified crown ruler 100. Advantageously, this visual analysis may proceed quickly and efficiently. The practitioner may then finalize T2 against the modified crown ruler 100.

With reference to FIGS. 1, 4, and 5, at 16, during the setup of T2, the practitioner fits the crown ruler 100 to the patient's digital information, for example the crown ruler 100 may be superimposed on a digital orthodontic setup 26 as is shown in FIG. 4. The digital orthodontic setup may be T1, T2, or a digital orthodontic setup that is an intermediate between T1 and T2.

Although deviations are not clearly shown in FIG. 4, it is expected that there will be deviations between the crown ruler 100 and the orthodontic digital setup in the preparation of T2. These deviations may include one or more differences in tooth dimensions, in tooth shapes, and in alignment, to name a few, between a digital tooth in the crown ruler 100 and a corresponding tooth in the digital orthodontic setup 26. Superimposing the crown ruler 100 on the digital orthodontic setup 26 enhances the practitioner's ability to visually identify deviations between the two. The crown ruler 100 improves the practitioner's capability of fine-tuning the digital orthodontic setup 26 in preparation of T2 and also enhances the practitioner's ability to bring the digital orthodontic setup 26 into alignment with the crown ruler 100 and to produce T2 more quickly. Ultimately, the crown ruler 100 enhances the patient's smile following treatment.

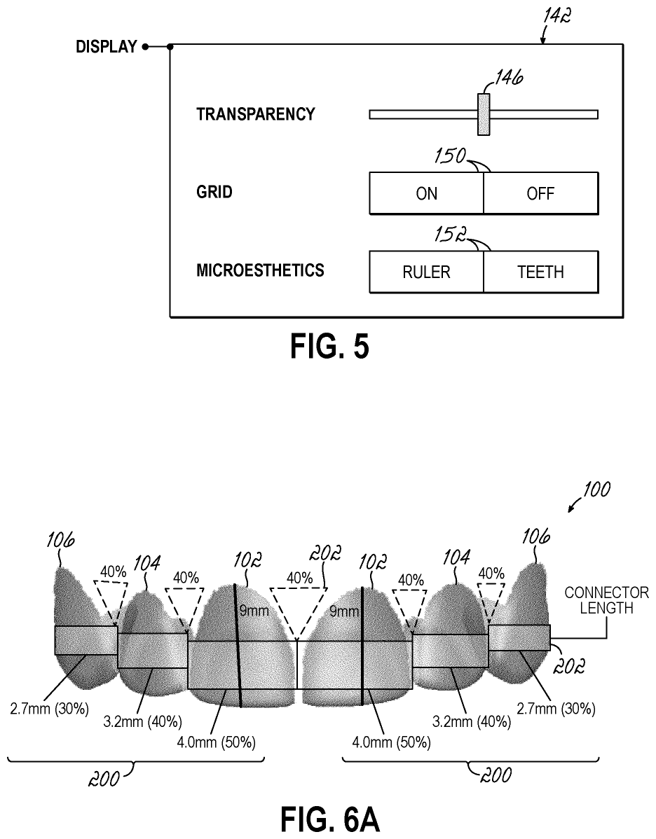

Embodiments of the invention include software tools and instructions to aid the clinician in identifying the discrepancies between the crown ruler 100 and a digital orthodontic setup, such as T2. The practitioner may adjust one or more of the settings on an exemplary user interface 142 shown in FIG. 5. With reference to FIG. 5, the practitioner may adjust a transparency of the crown ruler 100 relative to the digital orthodontic setup using a slider 146. During adjustment of the crown ruler 100 and/or the digital orthodontic setup 26, the practitioner may continuously vary the transparency to identify alignment and other issues between the crown ruler 100 and the digital orthodontic setup 26 as well as pinpoint any other visual discrepancies between the crown ruler 100 and the digital orthodontic setup 26. The practitioner may toggle the grid 114 on and off according to the buttons 150 and may also toggle the microesthetics selection 152 on and off for each of the ruler 100 and teeth 26. In this way, it is possible to display microesthetics one each at the same time. By way of example, microesthetics may be determined according to the Sarver Protocol (FIG. 1), which refers to techniques developed by Dr. Sarver of Vestavia Hills, Ala.

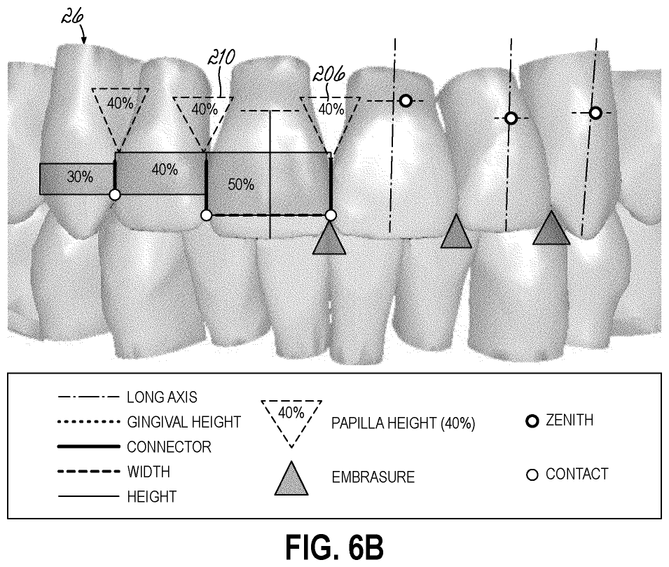

In that regard and with reference now to FIGS. 6A and 6B, toggling the microesthetics selection 152 for the “RULER” calculates a plurality of microesthetic values 200 and graphical information 202 (e.g., according to Sarver microesthetics) and displays those calculations on the crown ruler 100. The microesthetics of the ruler 100 are shown in FIG. 6A. As shown, the values 200 include connector height, height, papilla height, and embrasure measurements. With the RULER selection turned on, further modification via the settings 122 in the user interface 120 modifies the microesthetic values 200 and graphical information 202 that are calculated and displayed for the modified crown ruler 100. The practitioner can continuously repeat this cycle until the crown ruler 100 with specific microesthetics is achieved and/or the crown ruler 100 with a particular aesthetic appearance is produced. Armed with this capability, the practitioner is then able to quickly quantitatively comprehend the microesthetics of the crown ruler 100.

With reference to FIG. 6B, turning the microesthetics selection to on for “TEETH” according to the microesthetic selection 152 in FIG. 5, calculates a plurality of microesthetic values 206 and graphical information 210 on the digital orthodontic setup 26. This information may be identical to the information displayed with respect to the crown ruler 100, as shown in FIG. 6A. The microesthetics of the digital orthodontic setup 26 are shown in FIG. 6B. With the TEETH selection turned on, further modification of the digital orthodontic setup 26 modifies the microesthetic values calculated and displayed for the digital orthodontic setup 26. The microesthetics for each of the digital orthodontic setup 26 and the ruler 100 may be viewed simultaneously. Alternatively, the practitioner may toggle between the RULER and TEETH selections to alternate display of the microesthetic values 206 and graphical information 210 with the microesthetic values 200 and graphical information 202 and so more easily quantitatively compare the digital orthodontic setup with the crown ruler 100. With either process, that is simultaneous display or alternating display of the microesthetics, it will be appreciated that the practitioner may desire to converge the microesthetic values 206 and graphical information 210 of the digital orthodontic setup 26 with the microesthetic values 200 and graphical information 202 of the crown ruler 100 during preparation of T2.

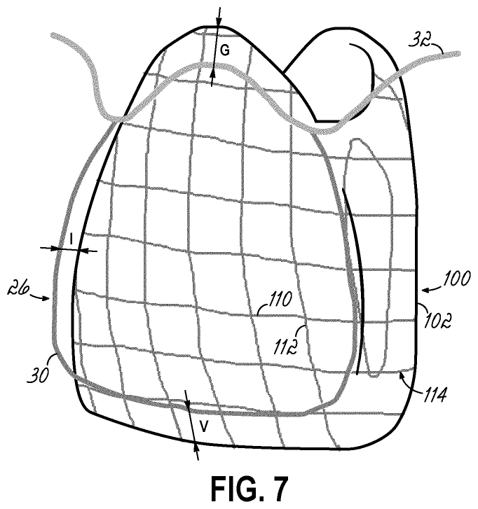

In view of the modifications and information possible with the crown ruler 100 via the user interfaces 120, 142 described above and with reference to FIG. 7, the practitioner can more easily visualize the individual tooth deviations between the digital orthodontic setup 26 and the corresponding teeth in the crown ruler 100. As shown in FIG. 7, a central incisor 102 of the crown ruler 100 is shown superimposed on a corresponding incisor 30 in the patient's digital orthodontic setup 26. Also shown in the patient's digital orthodontic setup is the gingival margin 32. With the aid of the grid 114, the practitioner is able to easily discern deviations from the crown ruler 100.

In this case, for example, if only a restorative treatment is desirable (i.e., no orthodontic treatment), the practitioner can make a quantitative evaluation that G units of gingiva removal, I units of inter-proximal reduction, and V units of build-up are required for the patient's digital orthodontic setup to match the incisor 102 of the crown ruler 100. Accordingly, the practitioner may identify that only restorative treatment is required to achieve the ideal tooth configuration shown in the crown ruler 100. The practitioner may ultimately recommend that the patient may only require restorative treatment.

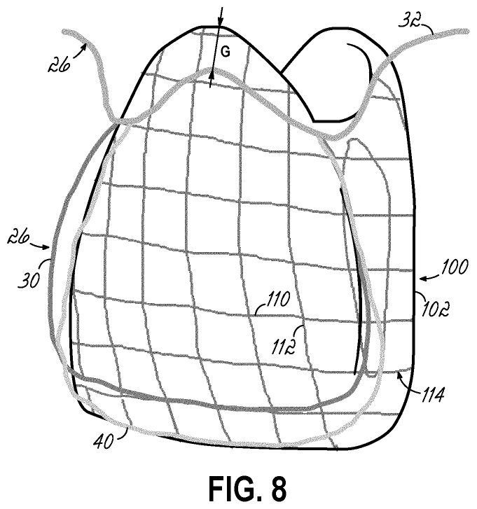

Alternatively, and with reference to FIG. 8, if the practitioner contemplates orthodontic treatment of the incisor 30 shown in FIG. 7, the practitioner may determine that extrusion of the incisor 30 to the location indicated at 40 that eliminates the need for reduction at I in FIG. 7 and for build-up at V in FIG. 7. G units of gingiva removal remain, however. Thus, the practitioner may recommend a combination of orthodontic treatment (extrusion) and restorative treatment (gingiva removal) by which the incisor 30 is matched to the incisor 102 of the crown ruler 100. Advantageously, the crown ruler 100 provides a visual, quantitative evaluation of the treatment options.

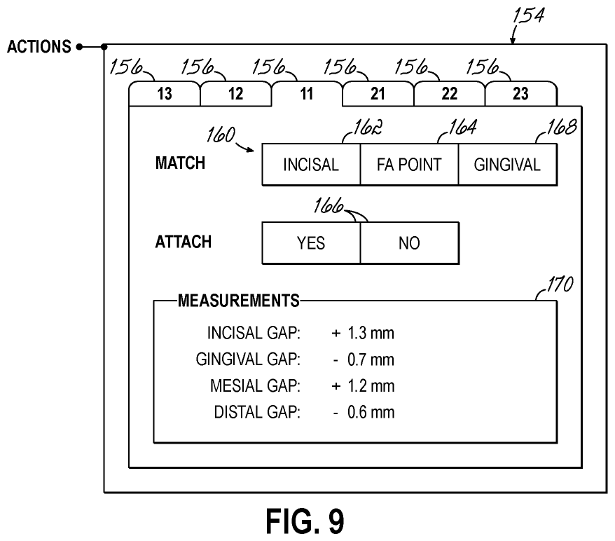

In one embodiment and with reference to FIG. 9, visual evaluations described with respect to FIGS. 7 and 8 may be quantified in a clinical assessment and actions interface 154. As shown, the interface 154 includes tooth number tabs 156 by which the practitioner selects which tooth is evaluated. On each tooth number tab 156, there is a match selection 160 giving the practitioner an option of automatically moving the crown ruler 100 to match the digital orthodontic setup 26 at an incisal edge 162 (“INCISAL”), at a facial axis point (“FA POINT”) 164, or at a gingival point (“GINGIVAL”) 168 at a corresponding tooth. The match selection 160 is essentially a quick-action button to achieve a certain alignment quickly. By way of example, the clinician may select any single one of the incisal edge 162, the facial axis point 164, or the gingival point 168 to achieve alignment between the selected tooth, e.g., 11, and the crown ruler 100 at the location selected instead of manually moving/reorienting the individual tooth in the setup 26 relative to the crown ruler 100.

With reference to FIG. 9, the clinical assessment and actions interface 154 also provides the practitioner with a capability of attaching the crown ruler 100 to the patient's digital orthodontic setup 26. The attach buttons 166 may be used in conjunction with the match selection 160, though embodiments are not limited to a cooperative arrangement of these functions. When the attach button 166 “YES” is selected, the tooth of the crown ruler 100 replaces the selected tooth in the setup 26. In essence, this may reflect a decision by the clinician to modify the shape of the patient's tooth in the setup 26 after or during orthodontic treatment to be the ideal tooth shape as represented by the crown ruler 100. This selection is reversible. If at a later time, the clinician desires to revisit the selected tooth, the button 166 “NO” is selected and the patient's tooth becomes visible.

When used in conjunction with the match selection 160, if YES is selected, the crown ruler 100 is attached to the patient's tooth indicated by the tab 156 and the location of attachment is either “INCISAL” or “FA POINT.” Subsequently, once attached, the tooth of the crown ruler 100 is utilized for the purpose of setting up T2 instead of the patient's tooth in the digital orthodontic setup 26. For example, if the tooth number tab 156 selected is number 11, and the practitioner selects the “FA POINT” 164 and the YES button 166 for attachment, the canine 106 of the crown ruler 100 (i.e., tooth number 11) is attached to the corresponding incisor of the patient's digital orthodontic setup 26 at the FA point. At that point, the canine 106 of the crown ruler 100 replaces the patient's incisor so that subsequent set up operations are based on the canine 106 of the crown ruler 100. The crown ruler 100 may be detached from the digital orthodontic setup 26 at any time.

The Attach function (i.e. buttons 166) may be utilized by a practitioner who plans treatment with a restorative technique. Referring to FIG. 7, for example, a practitioner may consider restorative techniques to address one or more of the gaps I, V, and G. So, with the Attach function activated (the YES button 166 is selected), the practitioner may focus on the ideal tooth position represented by the tooth 102 of the crown ruler 100, and the tooth 30 of the digital orthodontic setup 26 may not be further considered. This is because the practitioner will understand that the gaps between the digital orthodontic setup 26 and the crown ruler 100 will be compensated for by the planned restorative techniques.

On the other hand, the Attach function may not be utilized (the NO button 166 is selected) by a practitioner who plans treatment with orthodontic techniques. In that case, the crown ruler 100 would not attach to the digital orthodontic setup 26. Referring to FIG. 8, for example, the practitioner may plan to utilize orthodontic treatment to address gaps. Restorative treatments may not be utilized. In that case, the practitioner may focus on the digital orthodontic setup 26 to plan T2 with the goal of moving the tooth 30 into position at 40 to match the tooth 102 of the crown ruler 100.

While restorative only treatment and orthodontic only treatment are described above, a combination of restorative and orthodontic treatment may also be considered. For example, considering the tooth 30 in FIG. 7, a plan may include restorative treatment to address a portion of each gap and orthodontic treatment to address the remaining portion of each gap. The reverse treatment plan, i.e., orthodontic treatment and then restorative treatment is also contemplated.

In one embodiment, the actions interface 154 includes measurements 170 between the crown ruler 100 and the digital orthodontic setup 26. In the exemplary measurements, the action interface 154 indicates an incisional gap measurement, a gingival gap measurement, a mesial gap measurement, and a distal gap measurement. These values are automatically updated as changes are made to the crown ruler 100. By way of example only, the gaps provided in the measurements 170 are calculated as ideal minus real, that is, the crown ruler 100 position minus the position of the digital orthodontic setup 26, so that the sign of the measurements provides clinical meaning from a restorative treatment perspective. The measurements 170 may correspond to the visual assessment provided by the deviations visible between the grid 114 and the corresponding tooth in the digital orthodontic setup 26, such as that shown in FIG. 7.

Specifically, and with reference to FIG. 7, a positive incisal gap requires build-up to bring the tooth to the location of the corresponding tooth in the crown ruler 100. A negative incisal gap requires material to be removed or shaved off the tooth to bring that tooth to the location of the corresponding tooth in the crown ruler 100. A positive gingival gap requires gingiva removal. A positive mesial gap or positive distal gap requires build-up to bring the tooth to the position of the crown ruler 100, and a negative mesial gap or negative distal gap requires interproximal reduction to bring the tooth to the position of the crown ruler 100. Advantageously, the crown ruler 100 (FIG. 2) in combination with the user interfaces 120 (FIG. 3) and 142 (FIG. 5) and the actions interface 154 (FIG. 9) offer the practitioner the capabilities of editing the position and orientation of each individual tooth relative to the corresponding tooth of the crown ruler 100 and then observing qualitative and quantitative effects of those edits. The practitioner may then make clinical decisions to arrive at T2 in a more efficient manner and all the while the patient's smile is central to the development of T2.

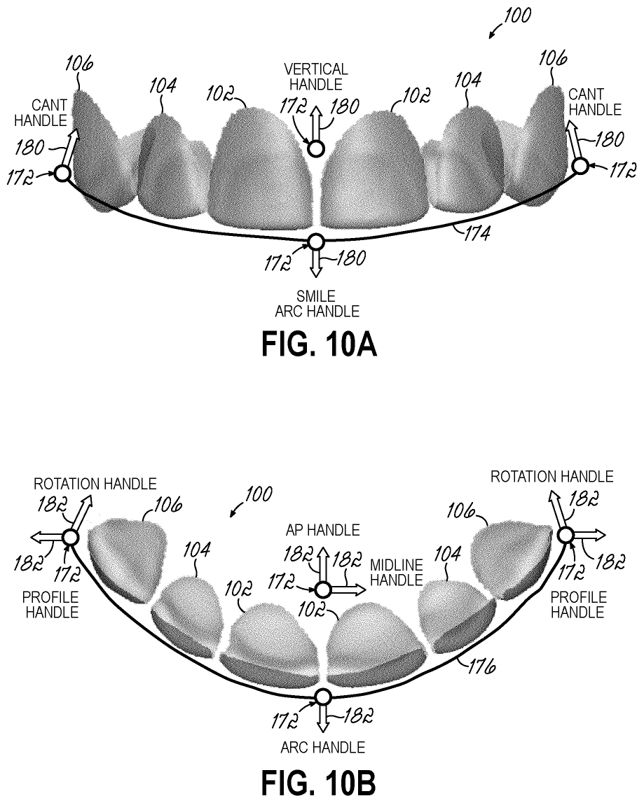

In one embodiment, and with reference to FIGS. 10A and 10B, a set of one or more tools 172 is available by which the practitioner can move the crown ruler 100 in a virtual space and manipulate a shape of an arc 174, 176 of the crown ruler 100. As shown, the tools 172 include one or more handles 180, 182 that the practitioner may digitally move. Each of the HANDLES 180, 182 adjusts the crown ruler 100 either bodily or modifies the shape of the crown ruler 100. Although not shown, modification of the crown ruler 100 via the tools 172 may be while the crown ruler 100 is superimposed on the digital orthodontic setup 26. Manipulating the shape of the crown ruler 100 via the tools 172 automatically causes the crown ruler 100 to rearrange and change in proportion along a new profile arc 174, 176 in accordance with the settings 122 (FIG. 3) described above.

For example, with reference to FIG. 10A, manipulating the VERTICAL HANDLE 180 bodily moves the entirety of the crown ruler 100 in an occlusal-gingival direction in digital space. The SMILE ARC HANDLE 180 modifies the shape of the arc 174. Selecting and moving the SMILE ARC HANDLE 180 in the direction of the arrow changes (i.e., decreases) a radius of the arc 174. In one embodiment, the arc 174 remains fixed at each CANT HANDLE 180 while the practitioner manipulates the SMILE ARC HANDLE 180. Thus, the arc 174 may be symmetrically stretched between the CANT HANDLES 180 and the SMILE ARC HANDLE 180. The reverse movement of the SMILE ARC HANDLE 180 is also possible, which increases a radius of the arc 174. By way of example only, manipulating SMILE ARC HANDLE 180 produces a symmetrical change in the arc 174. However, embodiments of the invention are not limited to symmetrical changes, and it is contemplated that asymmetrical changes to the arc 174 and to the arc 176 (FIG. 10B) are possible.

In one embodiment and with continued reference to FIG. 10A, the set of tools 172 includes a pair of CANT HANDLES 180. As shown, the CANT HANDLES 180 are located proximate each end of the arc 174. Movement of either one of the CANT HANDLES 180 rotates the crown ruler 100 about the VERTICAL HANDLE 180 or about another fixed location in the plane of FIG. 10A. Thus, the CANT HANDLES 180 may be utilized to adjust the rotational orientation of the entirety of the crown ruler 100 in an occlusal-gingival plane.

With reference to FIG. 10B, the clinician may move and modify the shape of the arc 176 via one or more of the HANDLES 182. By way of example, the AP HANDLE 182 allows the practitioner to bodily move the crown ruler 100 in an anterior-posterior direction. The MIDLINE HANDLE 182 allows the practitioner to bodily move the crown ruler 100 in a mesial-distal direction relative to a midline. As shown, the AP HANDLE 182 coincides with the MIDLINE HANDLE 182. The practitioner may bodily move the crown ruler 100 in the plane of FIG. 10B by selecting the AP HANDLE and MIDLINE HANDLE 182. The ROTATION HANDLES 182 are located proximate each end of the arc 176 and operate to bodily rotate the crown ruler 100 about a midpoint of the crown ruler 100, such as about ARC HANDLE 182, or around another location in the plane of FIG. 10B.

The practitioner may alter the shape of the arc 176 via the ARC HANDLE 182, which changes the radius of the arc 176 in the plane of FIG. 10B in the same way the ARC HANDLE 180 changes the shape of the arc 174 in the plane of FIG. 10A. In one embodiment, the arc 176 remains fixed at each ROTATION HANDLE 182 while the practitioner manipulates the ARC HANDLE 182. Thus, the arc 176 may be symmetrically stretched between the ROTATION HANDLES 182 and the ARC HANDLE 182. The reverse movement of the ARC HANDLE 182 is also possible, which increases a radius of the arc 176.

A pair of PROFILE HANDLES 182 allows the practitioner to change the shape of the arc 176. Selecting either one of the PROFILE HANDLES 182 and moving it in the direction indicated causes the arc 176 to flatten or increase in radius. This movement may produce a symmetrical or asymmetrical change in the arc 176. Furthermore, movement of one PROFILE HANDLE 182 in the opposing direction reduces the radius of the arc 176 and produces an increasingly curved arc 176. As shown, the PROFILE HANDLE 182 coincides with the ROTATION HANDLE 182 though embodiments of the invention are not limited to this configuration. All movements with the HANDLES 180 and 182 may be relative to the digital orthodontic setup 26. The tools 172 provide the practitioner with the capability of customizing a selected crown ruler 100 to T2 prior to making any final determinations as to orthodontic and/or restorative treatment.

Following movement of the crown ruler 100 with any of the tools 172, the visual widths of the teeth 102, 104, 106 of the crown ruler 100 are automatically modified to match one or both of the new profile arcs 174, 176 depending on movement of a particular HANDLE 180 and 182, and particularly with respect to SMILE ARC HANDLE 180, ARC HANDLE 182, and PROFILE HANDLES 182. In view of the modifications of the crown ruler 100 that are possible as is described above with respect to the interface 120 and tools 172, the appearance of the crown ruler 100 is automatically updated. In general, the modifications to the crown ruler 100 maintain symmetry so as to produce an ideal smile.

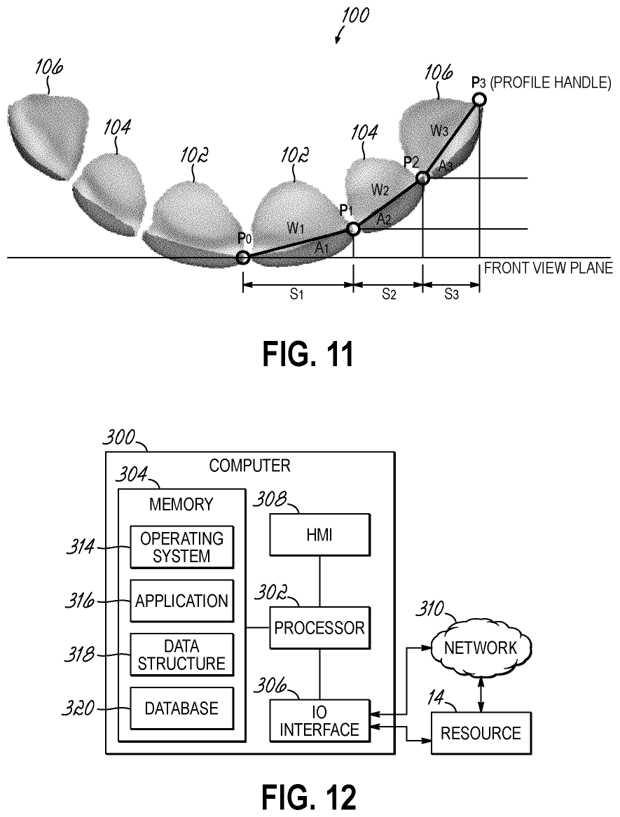

To that end, in one embodiment and with reference to FIG. 11, the visual width of each of the teeth 102, 104, 106 of the crown ruler 100 is represented as S1, S2, and S3, respectively. The practitioner may enter these values directly via the interface 120 (FIG. 3). For example, adjusting proportion values for any of the Centrals 128, Laterals 130, and/or Canines 132 modifies S1, S2, and S3, respectively, in proportion with the Size (H) 124. Similar modifications to S1, S2, and S3 may be effectuated by selecting either of the proportions GOLDEN 134 or RED 136. Selecting these options modify S1, S2, and S3 in accordance with the description set out above and are automatically visually observable in the crown ruler 100. With either method of changing any single one or all of S1, S2, and S3, either one or both the arcs 174, 176 automatically change shape.

Alternatively, or in addition to the interface 120, the practitioner may manipulate the tools 172 to modify the appearance of the crown ruler 100. In particular, the SMILE ARC HANDLE 180 (FIG. 10A) modifies the arc 174 and ARC HANDLE 182 and PROFILE HANDLE 182 (FIG. 10B) modify the arc 176. These modifications result in changes to S1, S2, and S3. Advantageously, visually manipulating the crown ruler 100 via the tools 172 may provide a more predictable visual result in the crown ruler 100. With regard to the visual modifications to S1, S2, and S3, with reference to FIG. 11, the points P0, P1, P2, and P3 are known in the three-dimensional space of the crown ruler 100. The widths W1, W2, and W3 of the teeth 102, 104, 106, respectively, are known according to the following:

|P0P1|=W1,

|P1P2|=W2,

|P2P3|=W3.

Calculation of the visual widths S1, S2, and S3 are obtained by automatically manipulating the vectors W1, W2, and W3. This calculation is completed by projecting in the top view (FIG. 11) and then projecting to the front view, such as is shown in FIG. 2. The visual widths S1, S2, S3 are then calculable according to: central incisors 102: S1/H; lateral incisors 104: S2/H; and canines 106: S3/H, where H in each calculation is specified in the interface 120. These calculations may be made for any change in the arcs 174, 176 by movement of one or more of the HANDLES 180, 182. For example, and with reference to FIG. 10A, selection of the SMILE ARC HANDLE 180 and movement of that handle in the direction indicated modifies the arc 174. Qualitatively, the elongation of the arch 174 increases each of W1, W2, and W3 (FIG. 11) in accordance with the proportions 128, 130, 132. The new W1, new W2, and new W3 are projected to the front automatically producing increased values for S1, S2, and S3 based on the new W values. A combination of direct input of proportions 128, 130, 132 and/or size (H) 124 and manipulation of the crown ruler 100 via the tools 172 is also possible. In that case, for example, the practitioner may directly insert values in proportions 128, 130, 132 and then move the SMILE ARC HANDLE 180 to fine tune the crown ruler 100 to visually match the digital orthodontic setup 26. Other combinations of direct entry of values and visual manipulation of tools 172 are possible and are contemplated herein.

With reference to FIG. 1, after any adjustments and modifications to the crown ruler 100 are made, the practitioner finalizes T2 and may submit T2 to a doctor for approval at 22. As indicated, the doctor may review T2 with the patient. During that review process, the doctor may modify T2.

At 28, an evaluation of whether T2 can be photomorphed to a patient's facial photograph is completed. In that process, the patient's pre-treatment facial photograph is modified based on T2. Advantageously, the patient can see a prediction of their face, and particularly their smile, as a result of an orthodontic treatment that produces T2. If the patient and/or doctor approves of their future smile, T2 is approved at 24. An unapproved T2 is redesigned at 30 where the doctor submits the necessary changes to the practitioner at 16.

The approved T2 translates directly to orthodontic appliance manufacturing. Orthodontic appliances, such as aligners 28 and orthodontic brackets 18, 24 (see, e.g., FIGS. 13, 14, and 15) may be manufactured compensating for dimensional information from one or more restorative treatments that are performed before, during, or after orthodontic treatment. These restorative treatments are identified and selected during development of T2 with the crown ruler 100. In FIG. 1, data including this information is sent to the manufacturer and is indicated at 34. By way of example only, in the case of Insignia, commercially available from Ormco Corporation, G codes for CNC manufacturing of custom orthodontic brackets are a direct result of the approved T2.

It is also contemplated that the DESIGN 16 and APPROVER 22 stages shown in FIG. 1 may be combined. In this situation, for example, following an intraoral scan of a patient's dentition, a doctor may consult with the patient and manipulate a crown ruler 100 in conjunction with the patient's digital images in the patient's presence. A T2 may be considered with the patient in conjunction with photomorphing the T2 with a current photograph of the patient. Multiple iterations of modifications to the crown ruler 100, setup of T2, and consideration of the patient's smile with that T2 may occur. Embodiments of the present invention, therefore, contemplate review of the patient's smile essentially in real-time with modification of the crown ruler 100. Thus, in a single consultation, the patient may receive an intraoral scan and then see a future image of themselves with a new smile.

According to embodiments of the invention, treatment according to methods described herein with the approved T2 may include a combination of both orthodontic and restorative treatments, only orthodontic treatment, or only restorative treatment. Advantageously, for a treatment that combines orthodontic and restorative treatments, T2 includes information for manufacturing customized orthodontic appliances that compensates for the restorative treatment that will occur before or after orthodontic treatment. Thus, the crown ruler 100 and tools described herein take the guesswork and trial and error out of the development of T2, which leads to more consistent and predictable smiles and clinical results on a patient-by-patient basis.

Referring now to FIG. 12, embodiments of the invention described above, or portions thereof, such as the design 16 and crown ruler library 20 or the design 16, the crown ruler library 20, and all of or a portion of the approver 22 may be implemented using one or more computer devices or systems, such as exemplary computer 300. The computer 300 may include a processor 302, a memory 304, an input/output (I/O) interface 306, and a Human Machine Interface (HMI) 308. The computer 300 may also be operatively coupled to one or more external resources 310, such as the crown library 20, via a network 312 and/or I/O interface 306. External resources may include, but are not limited to, servers, databases, mass storage devices, peripheral devices, cloud-based network services, or any other resource that may be used by the computer 300.

The processor 302 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 304. Memory 304 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, and/or data storage devices such as a hard drive, optical drive, tape drive, volatile or non-volatile solid state device, or any other device capable of storing data.

The processor 302 may operate under the control of an operating system 314 that resides in memory 304. The operating system 314 may manage computer resources so that computer program code embodied as one or more computer software applications, such as an application 316 residing in memory 304, may have instructions executed by the processor 302. In an alternative embodiment, the processor 302 may execute the application 316 directly, in which case the operating system 314 may be omitted. One or more data structures 318, for example one or more crown rulers 100 and the patient's digital orthodontic setup 26, may also reside in memory 304, and may be used by the processor 302, operating system 314, or application 316 and is manipulated by the practitioner.

The I/O interface 306 may provide a machine interface that operatively couples the processor 302 to other devices and systems, such as the external resource 310 or the network 312. The application 316 may thereby work cooperatively with the external resource 310 or network 312 by communicating via the I/O interface 306 to provide the various features, functions, applications, processes, or modules comprising embodiments of the invention. The application 316 may also have program code that is executed by one or more external resources 310, or otherwise rely on functions or signals provided by other system or network components external to the computer 300. Indeed, given the nearly endless hardware and software configurations possible, persons having ordinary skill in the art will understand that embodiments of the invention may include applications that are located externally to the computer 300, distributed among multiple computers or other external resources 310, or provided by computing resources (hardware and software) that are provided as a service over the network 312, such as a cloud computing service.

The HMI 308 may be operatively coupled to the processor 302 of computer 300 in a known manner to allow a practitioner to interact directly with the computer 300 to, for example, operate user interface 120. The HMI 308 may include video or alphanumeric displays, a touch screen, a speaker, and any other suitable audio and visual indicators capable of providing data to the user. The HMI 308 may also include input devices and controls such as an alphanumeric keyboard, a pointing device, keypads, pushbuttons, control knobs, microphones, etc., capable of accepting commands or input from the user and transmitting the entered input to the processor 302.

A database 320 may reside in memory 304 and may be used to collect and organize data used by the various systems and modules described herein. The database 320 may include data and supporting data structures, for example crown rulers 100 in the crown ruler library 20 and/or digital orthodontic setup 26, that store and organize the data. In particular, the database 320 may be arranged with any database organization or structure including, but not limited to, a relational database, a hierarchical database, a network database, or combinations thereof. A database management system in the form of a computer software application executing as instructions on the processor 302 may be used to access the information or data stored in records of the database 320 in response to a query, where a query may be dynamically determined and executed by the operating system 314, other applications 316, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures (e.g., the crown ruler library 20), program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an orthodontic appliance including instructions that implement the functions, acts, and/or operations specified in the flow-chart, sequence diagram, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-chart, sequence diagram, and/or block diagram of FIG. 1 may be re-ordered, processed serially, and/or processed concurrently consistent with embodiments of the invention. Moreover, any of the flow-chart, sequence diagram, and/or block diagram of FIG. 1 may include more or fewer blocks than those illustrated consistent with embodiments of the invention.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1.-20. (canceled)

21.-24. (canceled)

25. A method of dental treatment of a patient comprising:
superimposing a digital 3-D smile template of one or more 3-D model teeth with a digital orthodontic setup of a patient's teeth, the one or more 3-D model teeth being based on one or more predetermined criteria not associated with the patient;
identifying at least one difference between the one or more 3-D model teeth of the digital 3-D smile template and a corresponding one of the patient's teeth in the digital orthodontic setup; and
modifying the digital orthodontic setup of the patient's teeth to reduce the identified at least one difference; and
storing the modified digital orthodontic setup of the patient's teeth in a non-transitory medium for manufacturing one or more orthodontic appliances based on the modified digital orthodontic setup.

26. The method of claim 25 wherein, after storing the modified digital orthodontic setup, the method further includes manufacturing an orthodontic appliance based on the modified digital orthodontic setup.

27. The method of claim 25 wherein modifying includes reducing a difference between at least one of the predetermined criteria and the digital orthodontic setup of the patient's teeth.

28. The method of claim 25 wherein the one or more 3-D model teeth of the digital 3-D smile template includes a set of maxillary anterior 3-to-3 model teeth.

29. The method of claim 28 wherein the set of maxillary anterior 3-to-3 model teeth are arranged on an ideal arc.

30. The method of claim 25 wherein before modifying the digital orthodontic setup, the method further includes modifying an appearance of the digital 3-D smile template.

31. The method of claim 30 wherein the one or more 3-D model teeth includes an incisor and the one or more predetermined criteria includes an occlusal-gingival height of the incisor and wherein modifying the appearance of the digital 3-D smile template includes changing the occlusal-gingival height of the incisor.

32. The method of claim 31 wherein changing the occlusal-gingival height of the incisor automatically scales all the one or more 3-D model teeth by a proportional amount.

33. The method of claim 32 wherein the one or more 3-D model teeth includes an incisor and a canine and the one or more predetermined criteria includes a visual width relative to an occlusal-gingival height of the incisor and/or the canine and wherein modifying the appearance of the digital 3-D smile template includes changing the visual width relative to the occlusal-gingival height of the incisor and/or the canine.

34. The method of claim 30 wherein modifying the appearance of the digital 3-D smile template includes setting a ratio of the 3-D model teeth widths to be about 1.618:1 or setting a width ratio between a lateral incisor width and a canine width to be the same ratio as a width ratio of the lateral incisor width and a central incisor width.

35. The method of claim 30 wherein modifying the appearance of the digital 3-D smile template includes selecting teeth shapes from common shapes of teeth from a library of common tooth shapes.

36. The method of claim 25 wherein each 3-D model tooth includes a plurality of horizontal lines and a plurality of vertical lines conforming to a tooth surface of the one or more 3-D model teeth, and during superimposing, the horizontal lines and the vertical lines are visible relative to the digital orthodontic setup.

37. The method of claim 25 wherein modifying the digital orthodontic setup includes compensating for a restorative treatment after orthodontic treatment of the patient with an orthodontic appliance, the modified orthodontic setup of the patient's teeth differing from the digital 3-D smile template in the restorative treatment.

38. The method of claim 25 wherein storing the modified orthodontic setup includes storing dimensions on one or more restorative treatments that are to be performed before, during, or after orthodontic treatment.

39. The method of claim 25 wherein the modified digital orthodontic setup differs from the digital 3-D smile template in at least one of gingival alteration, hard tissue build-up, or hard tissue removal on at least one tooth of the patient.

40. The method of claim 25 wherein prior to modifying the digital orthodontic setup, the method further includes calculating one or more microesthetics of the digital 3-D smile template including one or more of connector height, height, papilla height, and embrasure measurement and displaying the calculated microesthetics in relation to the digital 3-D smile template.

41. The method of claim 40 wherein modifying the digital orthodontic setup of the patient's teeth includes calculating and displaying microesthetics of the digital orthodontic setup and further includes converging the calculated microesthetics of the modified digital orthodontic setup with the calculated one or more microesthetics of the digital 3-D smile template.

42. An orthodontic appliance for dental treatment of a patient made from the modified digital orthodontic setup of claim 25, the appliance comprising:
one of an aligner and an orthodontic bracket which includes a dimension that compensates for a restorative treatment performed on the patient before, during, or after orthodontic treatment of the patient with the aligner or orthodontic bracket.

43. A computer program product for smile design comprising:
a non-transitory computer-readable storage medium; and
program code stored on the non-transitory computer-readable storage medium that, when executed by a processor, causes the processor to:
retrieve a first data structure that defines a digital 3-D smile template of at least two teeth arranged in accordance with predetermined criteria from a memory;
retrieve a second data structure that defines an orthodontic setup of a patient's teeth from the memory;
superimpose the digital 3-D smile template with the digital orthodontic setup of a patient's teeth;
display the superimposed digital 3-D smile template and the digital orthodontic setup;
modify the digital orthodontic setup of the patient's teeth to reduce an identified difference between the one or more 3-D model teeth of the digital 3-D smile template and a corresponding one of the patient's teeth in the digital orthodontic setup; and
store the modified digital orthodontic setup of the patient's teeth in a non-transitory medium for manufacturing one or more orthodontic appliances based on the modified digital orthodontic setup.

44. An apparatus for smile design including a computer having a processor comprising:
a memory coupled to the processor, the memory storing a first data structure that defines a digital 3-D smile template of at least two teeth arranged in accordance with predetermined criteria;
program code that, when executed by the processor, causes the computer to:
retrieve a second data structure that defines an orthodontic setup of a patient's teeth from the memory; and
superimpose the digital 3-D smile template with the digital orthodontic setup of a patient's teeth; and
a user interface for selectively displaying the digital 3-D smile template with respect to the digital orthodontic setup and the program code, when executed by the processor, further causes the computer to:
display the superimposed digital 3-D smile template and the digital orthodontic setup;
receive a user selected identified difference between the one or more 3-D model teeth of the digital 3-D smile template and a corresponding one of the patient's teeth in the digital orthodontic setup;
modify the digital orthodontic setup of the patient's teeth to reduce the identified difference; and
store the modified digital orthodontic setup of the patient's teeth in a non-transitory medium for manufacturing one or more orthodontic appliances based on the modified digital orthodontic setup.
